(19) United States
(12) Patent Application Publication
(10) Pub. No.: US 2024/0019836 A1
(43) Pub. Date: Jan. 18, 2024

(54) METHOD FOR MANAGING MOTION INFORMATION, ELECTRONIC DEVICE, AND STORAGE MEDIUM

(71) Applicant: Fulian Precision Electronics (Tianjin) Co., LTD., Tianjin (CN)

(72) Inventors: CHENG-YU WANG, New Taipei (TW); PO-CHENG CHEN, New Taipei (TW); YU-TE LEE, New Taipei (TW); TSUNG-SHENG CHEN, New Taipei (TW)

(21) Appl. No.: 18/140,522

(22) Filed: Apr. 27, 2023

(30) Foreign Application Priority Data
Jul. 18, 2022 (CN) 202210843570.1

(51) Int. Cl. G05B 19/4063

(52) U.S. Cl. CPC G05B 19/4063; G05B 2219/32366

(57) ABSTRACT

A method for managing motion information is provided. The method obtains a motion document of a first operation target. The motion document of the first operation target recording information of motions of the first operation target. The method generates guiding information according to the motion document of the first operation target. The guiding information is configured to guide motions of second operation targets. The method obtains motion images of each second operation target. The method identifies information of motions of each second operation target from the motion images of each second operation target. The method further determines a pass rate of the motions of each second operation target according to the information of the motions of the first operation target and the information of the motions of each more second operation target. A related electronic device and a related non-transitory storage medium are provided.

### FIELD

The subject matter herein generally relates to an artificial intelligence technology, and particularly to a method for managing motion information, an electronic device, and a storage medium.

### BACKGROUND

Standardized work is an important link in a building of a digitalized factory. Nowadays, the standardized work of the factory usually provides a unified standardized work document, and performs a programmatic and a standardization management according to the standardized work document. However, it is difficult to efficiently evaluate a result of the standardized work.

### SUMMARY

An embodiment of the present application provides a method for managing motion information, an electronic device, and a storage medium which are capable of efficiently evaluating a result of the standardized work.

In a first aspect, an embodiment of the present application provides a method for managing motion information. The method includes obtaining a motion document of a first operation target. The motion document of the first operation target records information of one or more motions of the first operation target. The method includes generating guiding information according to the motion document of the first operation target. The guiding information is configured to guide one or more motions of one or more second operation targets. The method includes obtaining one or more motion images of each of the one or more second operation targets. The method includes identifying information of one or more motions of each of the one or more second operation targets from the one or more motion images of each of the one or more second operation targets. The method includes determining a pass rate of the one or more motions of each of the second operation targets according to the information of the one or more motions of the first operation target and the information of the one or more motions of each of the one or more second operation targets.

According to some embodiments of the present application, the method includes comparing the information of the one or more motions of each of the second operation targets with the information of the one or more motions of the first operation target one motion by one motion. The method includes determining whether the one motion of the second operation targets is passed one second operation target by one second operation target. The method further includes determining the pass rate of the one or more motions of each of the second operation targets according to a first number and a second number. The first number is a number of the motions of each of the second operation targets having pass. The second number is a total number of the motions of each of the second operation targets to pass.

According to some embodiments of the present application, the method includes determining whether one or more deviations are within an error range, the one or more deviations being differences in the one motion between the one second operation target and the first operation target. The method further includes determining that the one motion of the one second operation target has passed if the one or more deviations are within the error range.

According to some embodiments of the present application, the method further includes determining whether an angle of a rotation of a head is within a first error range according to one or more positions of a reference point of the head in corresponding motion images of the second operation target. The method further includes determining whether a motion track of a body is within a second error range according to one or more positions of one or more reference points of the body in corresponding motion images of the second operation target.

According to some embodiments of the present application, the method includes searching the motion document in a first database according to a name or one or more first keywords of the motion document. The first database is configured to store one or more motion documents with a nature language format. The method includes searching the motion document in a second database according to a motion track of one or more reference points corresponding to at least one action of the one or more actions of the one or more motion. The second database is configured to store one or more motion documents of the first operation target with a machine language format.

According to some embodiments of the present application, the method includes obtaining one or more motion images of the first operation target, and identifying information of the one or more motions of the first operation target from the one or more motion images of the first operation target. The method further includes recording the information of the one or more motions of the first operation target to form the motion document and storing the motion document to the database.

According to some embodiments of the present application, the method includes determining one or more second keywords corresponding to each of the one or more motions of the first operation target and counting a frequency of occurrence of each of the one or more second keywords to prompt a possibility of one or more repeating motions of the second operation target.

According to some embodiments of the present application, the method includes generating an alarm if the pass rate of the one or more motions of a second operation target of the one or more second operation targets is less than a first threshold value. The alarm is configured to prompt that the one or more motions of the second operation target have failed.

The electronic device generates the guiding information to guide the one or more motions of the second operation target according to the motion document which records the one or more motions of the first operation target. The electronic device identifies the one or more motions of the second operation target from the one or more motion images of the second operation target, and determines the pass rate of the motions of the second operation target according to the information of the motions of the first operation target and the information of the motions of the second operation target. Thus, the disclosure can quantitatively evaluate the motions of the second operation target by taking the motions of the first operation target as a reference, and a result of the standardized work can be efficiently evaluated accordingly. Thereof, an efficient reference basis can be provided for optimizing a manner for managing the standardized work.

In a second aspect, an embodiment of the present application provides an electronic device. The electronic device includes a storage unit, and at least one processor. The storage unit stores one or more programs, which when executed by the at least one processor, cause the at least one processor to obtain a motion document of a first operation target. The motion document of the first operation target records information of one or more motions of the first operation target. The electronic device further causes the at least one processor to generate guiding information according to the motion document of the first operation target. The guiding information is configured to guide motions of one or more second operation targets. The electronic device further causes the at least one processor to obtain one or more motion images of each of the one or more second operation targets and identifies information of one or more motions of each of the one or more second operation targets from the one or more motion images of each of the one or more second operation targets. The electronic device further causes the at least one processor to determine a pass rate of the one or more motions of each of the second operation targets according to the information of the one or more motions of the first operation target and the information of the one or more motions of each of the one or more second operation targets.

In a third aspect, an embodiment of the present application also provides a non-transitory storage unit. The non-transitory storage medium stores a set of commands, when the commands being executed by at least one processor of an electronic device, causing the at least one processor to obtain a motion document of a first operation target. The motion document of the first operation target records information of one or more motions of the first operation target. The non-transitory storage medium further causes the at least one processor to generate guiding information according to the motion document of the first operation target. The guiding information is configured to guide motions of one or more second operation targets. The non-transitory storage medium further causes the at least one processor to obtain one or more motion images of each of the one or more second operation targets and identifies information of one or more motions of each of the one or more second operation targets from the one or more motion images of each of the one or more second operation targets. The non-transitory storage medium further causes the at least one processor to determine a pass rate of the one or more motions of each of the second operation targets according to the information of the one or more motions of the first operation target and the information of the one or more motions of each of the one or more second operation targets.

Details of the second aspect, the third aspect, and their implementation embodiments can refer to the description of the first aspect and the implementation embodiments of the first aspect, and details are not described herein again. Advantages of the second aspect, the third aspect, and their implementation embodiments can refer to advantages of the first aspect and the implementation embodiments of the first aspect, and details are not described herein again.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is a schematic view of an embodiment of a system for managing motion information.

FIG. 2 is a flowchart of an embodiment of a method for managing motion information.

FIG. 3 is a flowchart of an embodiment of a process of determining a pass rate of motions of each second operation target according to information of motions of a first operation target and information of motions of each second operation target.

FIG. 4 is a flowchart of an embodiment of a process of determining whether the one motion of the one or more second operation targets have passed one second operation target of the one or more second operation targets by one second operation target of the one or more second operation targets.

FIG. 5 is a flowchart of an embodiment of a process before obtaining a motion document of the first operation target.

FIG. 6 is a flowchart of an embodiment of a process before recording information of motions of the first operation target to form the motion document.

### DETAILED DESCRIPTION

In this application, “at least one” refers to one or more, and “a plurality of” refers to two or more. A term “and/or” describes an association relationship for describing associated targets and represents that three relationships may exist. For example, A and/or B may represent the following three cases: only A exists, both A and B exist, and only B exists. A and B may be in a singular or plural form. In the specification, claims, and accompanying drawings of the present disclosure, the terms “first”, “second”, “third”, “fourth” and so on are intended to distinguish between similar targets but are not intended to indicate specific order or a sequence.

It is noted that, the methods disclosed in the disclosure or shown in the flowcharts comprise one or more steps or actions for achieving the methods. The method steps and/or actions may be interchanged with one another, and fewer steps can be utilized without departing from the scope of the claims.

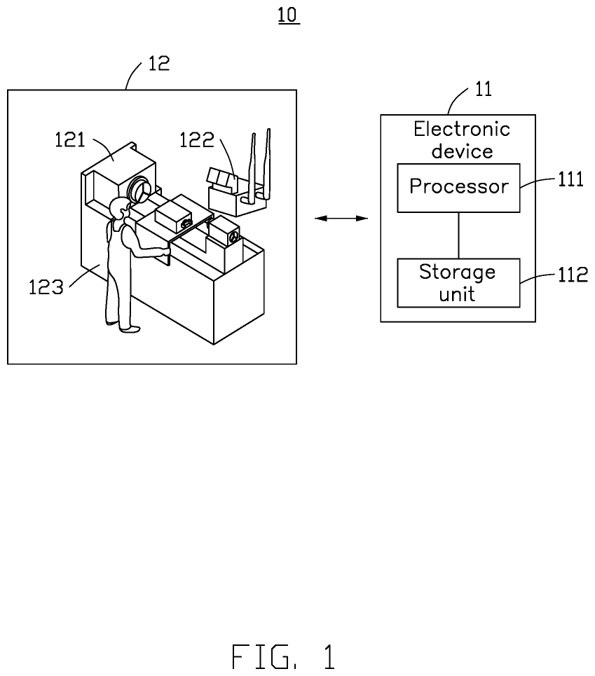

Referring to FIG. 1, a system for managing motion information is shown. In the FIG. 1, the system 10 includes an electronic device 11 and a number of workstations 12. The electronic device 11 can communicate with the workstations 12. In some embodiments, the electronic device 11 can communicate with the workstations 12 via a wired connection, such as an optical fiber connection or a copper wire connection. In some embodiments, the electronic device 11 can communicate with the workstations 12 via a wireless connection such as a Wi-Fi connection or a cellular data connection. Each workstation 12 can upload the data to the electronic device 11 and can download the data from the electronic device 11.

Each workstation 12 can include a machine 121, one or more cameras 122, and an operation target 123. The operation target 123 operates near the machine 121. The operation target 123 can be a robot or an operator. The one or more cameras 122 can capture the operation target 123 at a preset time interval (for example 2 second), to generate one or more motion images of the operation target 123. The electronic device 11 can obtain the motion images of the operation target 123 from the cameras 122.

The electronic device 11 can include at least one processor 111 and a storage unit 112. One or more programs are stored in the storage unit 112 and can be run on the at least one processor 111 to accomplish various functions of the electronic device 11, for example to accomplish the method for managing motion information.

The processor 111 may include one or more processing units. For example, the processor 111 may include an application processor (application processor, AP), a modem processor, a graphics processing unit (graphics processing unit, GPU), an image signal processor (image signal processor, ISP), a controller, a video codec, a digital signal processor (digital signal processor, DSP), a baseband processor, a neural network processing unit (neural-network processing unit, NPU), and/or the like. Different processing units may be independent components, or may be integrated into one or more processors.

A memory may be further disposed in the processor 111, and is configured to store an instruction and data. In some embodiments, the memory in the processor 111 is a cache memory. The memory may store instructions or data that has just been used or is cyclically used by the processor 111. If the processor 111 needs to use the instructions or the data again, the processor 111 may directly invoke the instructions or the data from the memory.

In some embodiments, the processor 111 may include one or more interfaces. The interface may include an inter-integrated circuit (inter-integrated circuit, I2C) interface, an inter-integrated circuit sound (inter-integrated circuit sound, I2S) interface, a pulse code modulation (pulse code modulation, PCM) interface, a universal asynchronous receiver/transmitter (universal asynchronous receiver/transmitter, UART) interface, a mobile industry processor interface (mobile industry processor interface, MIPI), a general-purpose input/output (general-purpose input/output, GPIO) interface, a subscriber identity module (subscriber identity module, SIM) interface, a universal serial bus (universal serial bus, USB) port, and/or the like.

It may be understood that an interface connection relationship between the modules shown in the embodiments of the present invention is merely used as an example for description, and does not constitute a limitation on the structure of the electronic device 11. In some other embodiments of this application, the electronic device 11 may alternatively use an interface connection manner different from that in the foregoing embodiment, or a combination of a plurality of interface connection manners.

The storage unit 112 may include an external memory interface and an internal memory. The external memory interface may be configured to connect to an external memory card such as a micro SD card, to extend a storage capability of the electronic device 11. The external memory card communicates with the processor 111 through the external memory interface, to implement a data storage function. The internal memory may be configured to store computer-executable program code. The executable program code includes instructions. The internal memory may include a program storage area and a data storage area. The program storage area may store an application required by at least one function (for example, a sound playing function or an image playing function), and the like. The data storage area may store data (for example, audio data, a phone book, and the like) created in a process of using the electronic device 11, and the like. In addition, the internal memory may include a highspeed random access memory, or may include a nonvolatile memory, for example, at least one magnetic disk storage device, a flash memory device, or a universal flash storage (universal flash storage, UFS). The processor 111 runs the instructions stored in the internal memory and/or the instructions stored in the memory of the processor 111, to perform various function applications of the electronic device 11 and process data, for example the exemplary method.

It may be understood that the structure shown in the embodiments of this application does not constitute a specific limitation on the electronic device 11. In some other embodiments of this application, the electronic device 11 may include more or fewer components than those shown in the figure, or some components may be combined, or some components may be split, or different component arrangements may be used. The components in the figure may be implemented by hardware, software, or a combination of software and hardware.

The electronic device 11 may include, but is not limited to, a smart phone, a tablet personal computer, a personal computer, a server such as a cloud server or a local server, a personal digital assistant, or the like.

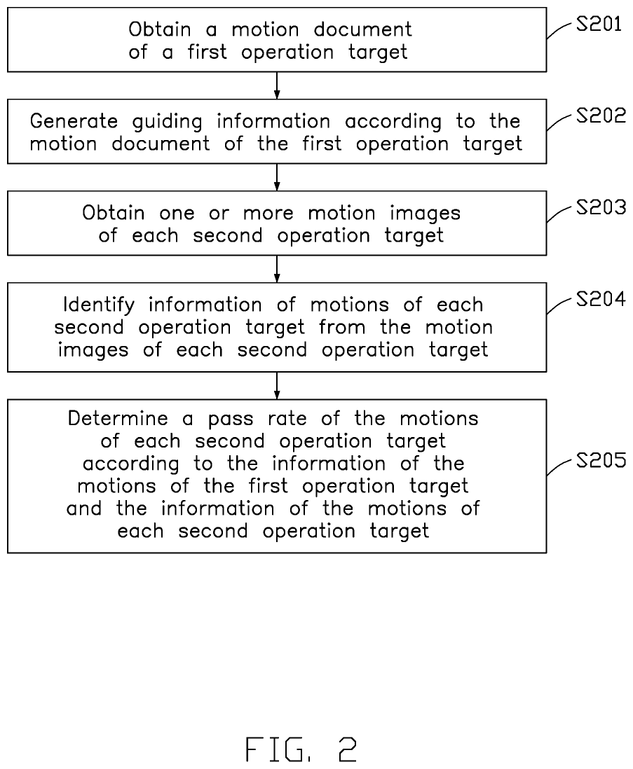

FIG. 2 is a flowchart of an embodiment of a method for managing motion information. The method can be applied on an electronic device. The method includes:

S201, obtaining a motion document of a first operation target.

The motion document of the first operation target is configured to record information of one or more motions of the first operation target. A format of the motion document of the first operation target can include a nature language format and/or a machine language format.

The motion document of the first operation target with the nature language format can record the information of the motions of the first operation target, for example, no rotating of a head, a moving of a left hand toward a left direction being about 20 centimeters, and a moving of a right hand toward the left direction being about 10 centimeters.

The motion document of the first operation target with the machine language format can record the information of the motions of the first operation target, for example:
head_roll=0
head_pitch=0
head_yaw=0
hand_up_left=x,y
hand_down_left=x,y
hand_up_right=x,y
hand_down_right=x,y

In the embodiment, the head_roll, the head_pitch, the head_yaw are respectively a roll angle of the rotation of the head, a pitch angle of the rotation of the head, and a yaw angle of the rotation of the head. The hand_up_left and the hand_down_left are respectively a sets of motion vector coordinate data of a left upper arm and a sets of motion vector coordinate data of a left lower arm. The hand_up_right and the hand_down_right are respectively a sets of motion vector coordinate data of a right upper arm and a sets of motion vector coordinate data of a right lower arm. It can be understood that, the moving of the left upper arm, the moving of the left lower arm, the moving of the right upper arm, and the moving of the right lower arm represent a moving of a body.

The angle of the rotation of the head such as the roll angle, the pitch angle, and the yaw angle, and the sets of motion vector coordinate data of a body such as the left upper arm, the left lower arm, the right upper arm, and the right lower arm each represents a motion track of one or more reference points corresponding to one motion. The one or more reference point corresponding to one motion can be any one or more points of the corresponding part of the operation target. For example, a point of the left eye (or the right eye) can be the reference point corresponding to a rotation of the head, and a point of the left shoulder, a point of the right shoulder, a point of the left elbow, and a point of the right elbow can be the reference points corresponding to a moving of the body. In the embodiment, a head_roll=a represents that the roll angle of the rotation of the head is a when taking the corresponding reference point as the head, where −180≤a≤180. The hand_up_left=x,y represents that the right movement distance of the left upper arm is x and the upper movement distance of the left upper arm is y when taking the corresponding reference point as the left upper arm, where x and y can be any value. For example, a hand_up_left=20, 10 represents that the right movement distance of the left upper arm is 20 centimeters, and the upper movement distance of the left upper arm is 10 centimeters, and a hand_up_left=−20, −10 represents that the left movement distance of the left upper arm is centimeters, and the lower movement distance of the left upper arm is 10 centimeters. A representation of the hand_down_left, a representation of the hand_up_right, and a representation of the hand_down_right each is similar to a representation of the hand_up_left=x,y, which is not described herein.

In some embodiments, the motion document of the first operation target with the nature language format is stored in a first database. The motion document of the first operation target with the machine language format is stored in a second database. In some embodiments, the first database and the second database can be the database of the electronic device. In some embodiments, the first database and the second database can be an external database which can be accessed by the electronic device.

In some embodiments, the electronic device can search the first database according to a name or some first keywords of the motion document of the first operation target.

For example, to search the motion document of the first operation target with the nature language format, some contents are inputted, such as no rotating of the head, the moving of the left hand toward the left direction being about 20 centimeters, and the moving of the right hand toward the left direction being about 10 centimeters. The electronic device can receive the inputted contents, and perform a text segmentation or a semantic segmentation on the inputted contents to extract one or more first keywords, such as the first keywords: the head, no, rotating, the left hand, toward, left, moving, about, 20, centimeters, the right hand, toward, left, moving, about, 10, centimeters. The electronic device can further search the first database according to the first keywords, to obtain the motion document of the first operation target which records the information of the motions of the first operation target, for example, no rotating of the head, the moving of the left hand toward the left direction being about 20 centimeters, and the moving of the right hand toward the right direction being about 10 centimeters. It can be understood that, the inputted contents can be the first keywords, the disclosure is not limited herein.

In some embodiments, the electronic device can search the second database according to the motion track of the one or more reference points corresponding to at least one action of the motions. Each motion includes one or more actions.

For example, in the second database, the motion document of the first operation target with the machine language format records the information of the motions of the first operation target, such as:
head_roll=0
head_pitch=0
head_yaw=0
hand_up_left=x,y
hand_down_left=x,y
hand_up_right=x,y
hand_down_right=x,y

The electronic device can search the motion track of the reference points corresponding to at least one action of at least one motion in the second database, for example, search “hand_up_left=x,y” to obtain the motion document of the first operation target.

The motion document of the first operation target can further record one or more timestamps. Each timestamp corresponds to one or more motions. Or, the motion document of the first operation target can further record a number of continuous timestamps when the one or more motions occurred. For example, for the motion such as no rotating of the head, the moving of the left hand toward the left direction being about 20 centimeters, and the moving of the right hand toward the left direction being about 10 centimeters, the motion document of the first operation target records the continuous timestamps from an initial position of the first operation target to the motion of the first operation target being completed, and records the continuous action of the motion corresponding to the timestamps from an initial position of the first operation target to the motion of the first operation target being completed. Where each motion includes a number of actions. Or, the motion document of the first operation target can omit the timestamps, but record a sequence of the one or more motions.

For the convenience of description, each timestamp corresponding to one or more motions can be used as an example to illustrate the disclosure, the disclosure is not limited herein.

S202, generating guiding information according to the motion document of the first operation target.

The guiding information is configured to guide one or more motions of one or more second operation targets. For the convenience of description, more second operation targets can be used as an example to illustrate the disclosure.

In some embodiments, a type of the guiding information can be at least one of a group consisting of an audio, a video, an animation, and a text.

For example, the electronic device can convert the motion document of the first operation target to audio information, and broadcast the audio information via an audio unit such as a loudspeaker. Thus, the method can guide the motions of the second operation targets. For example, the electronic device can convert the motion document of the first operation target to video information (or the animation, or the text), and display the video information on a display panel. Thus, the method can guide the motions of the second operation targets.

S203, obtaining one or more motion images of each second operation target.

In the embodiment, the one or more cameras in each workstation can capture the second operation target at a preset time intervals, to generate one or more motion images of the second operation target. Thus, the electronic device can obtain the motion images of each second operation target.

In some embodiments, the cameras can be controlled by the electronic device, and begins to capture after receiving one or more control commands from the electronic device.

In some embodiments, before S203, the electronic device can employ a hand-eye calibration method to calibrate the position of the cameras, to generate an appropriate installed position of the cameras.

S204, identifying information of motions of each second operation target from the motion images of each second operation target.

In some embodiments, the method can select the same one or more reference points of each second operation target in the motion images of each second operation target which are arranged in a sequential order of the capturing time, calculate the position change of each reference point in the motion images of each second operation target, to determine the angle of the rotation of the head of each second operation target and the sets of the motion vector coordinate data of the body of each second operation target. Thus, the information of the motions of each second operation target can be identified.

For example, the electronic device can select a point of the left eye as the reference point corresponding to a rotation motion of the head in the motion images of one second operation target which are arranged in a sequential order in the capturing time. The electronic device can further select a point of the left shoulder, a point of the right shoulder, a point of the left elbow, and a point of the right elbow as the reference points corresponding to a moving motion of the body in the motion images of the one second operation target which are arranged in a sequential order in the capturing time. An initial position of each second operation target is that the head_roll=0, the head_pitch=0, the head_yaw=0, the hand_up_left=0, 0, the hand_down_left=0, 0, the hand_up_right=0, 0, and the hand_down_right=0, 0. The electronic device can determine that an angle of the rotation of the head of the one second operation target according to the motion images of the one second operation target at a first moment is that the head_roll=0, the head_pitch=0, and the head_yaw=0, and determine that the sets of the motion vector coordinate data of the body of the one second operation target according to the motion images of the one second operation target at the first moment is that the hand_up_left=the hand_down_left=20, −5, the hand_up_right=10, −5, and the hand_down_right=Thus, the electronic device can determine a first motion of the one second operation target being that: the moving of the left upper arm, the moving of the right upper arm, and the moving of the right lower arm each toward a right direction is about 10 centimeters; the moving of the left lower arm toward a right direction is about 20 centimeters; the moving of the left upper arm, the moving of the left lower arm, the moving of the right upper arm, and the moving of the right lower arm each toward a down direction is about 5 centimeters. The electronic device can determine that an angle of the rotation of the head of the one second operation target according to the motion images of the one second operation target at a second moment is that the head_roll=0, the head_pitch=0, and the head_yaw=30, and determine that the sets of the motion vector coordinate data of the body of the one second operation target according to the motion images of the one second operation target at the second moment is that the hand_up_left=20, 5, the hand_down_left=20, 5, the hand_up_right=0, −20, and the hand_down_right=0, −20. Thus, the electronic device can determine a second motion of the one second operation target is that: a yaw angle of the rotation of the head toward an up direction is 30 degrees, the moving of the left upper arm and the moving of the left lower arm each toward the right direction is 20 centimeters, the moving of the left upper arm and the moving of the left lower arm each toward the up direction is 5 centimeters, and the moving of the right upper arm and the moving of the right lower arm each toward the down direction is 20 centimeters.

S205, determining a pass rate of the motions of each second operation target according to the information of the motions of the first operation target and the information of the motions of each second operation target.

In some embodiments, the electronic device can arrange the motions in the information of the motions of each second operation target in a sequential order of the capturing time to form information of a whole of the motions of each second operation target. The electronic device further compares the information of the motions of each second operation target and the information of the motions of the first operation target one motion by one motion according to the timestamp and the capturing time, to determine whether the one motion of the second operation targets have passed one second operation target by one second operation target by taking the motion of the first operation target as a standard motion. The electronic device further determines a number of the motions of each second operation target having passed to be a first number, determines a total number of the motions of each second operation target to pass to be a second number, and determines a rate of the first number to the second number. Thus, the pass rate of the motion of each second operation target can be determined.

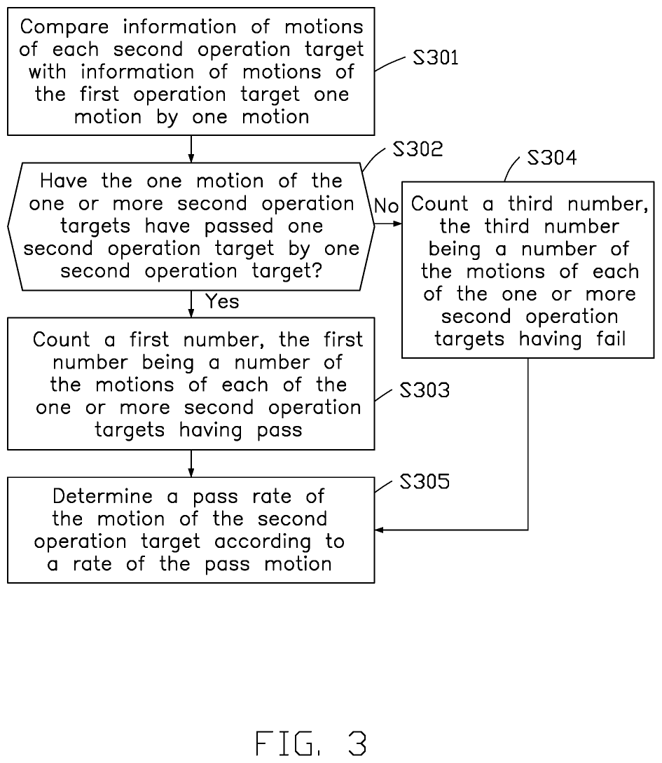

In detail, a process of determining a pass rate of motions of each second operation target according to information of motions of the first operation target and the information of motions of each second operation target includes, as shown in FIG. 3:

S301, comparing the information of the motions of each second operation target with the information of the motions of the first operation target one motion by one motion.

It can be understood that, the guiding information is generated according to the information of the motions of the first operation target recorded in the motion document of the first operation target. And, the second operation target performs one or more motions according to the guiding information. Thus, each motion of the second operation target corresponds to one motion of the first operation target.

For example, timestamps of all the motions of the first operation target are between 10:00 and 10:05, and the cameras captures an image every 2 seconds, the capturing time of all the motions of the second operation target are between 15:00 and 15:05, thus each motion of the second operation target during the capturing time between 15:00 and 15:05 corresponds to one motion of the first operation target during the timestamps between 10:00 and 10:05. For example, the motion of the second operation target at the capturing time 15:01 corresponds to the motion of the first operation target at a timestamp 10:01.

In the embodiment, the electronic device compares the motion of each second operation target at each capturing time with the action of the motion of the first operation target at a corresponding timestamp, to compare the information of the motions of each second operation target with the information of the motions of the first operation target one motion by one motion.

S302, determining whether the one motion of the one or more second operation targets have passed one second operation target by one second operation target.

In the embodiment, the electronic device compares the one motion of each second operation target at each capturing time with the one motion of the first operation target at a corresponding timestamp, to determine whether a difference is existed in the one motion between the one second operation target and the first operation target, thus the method can determine whether the one motion of the one or more second operation targets have passed.

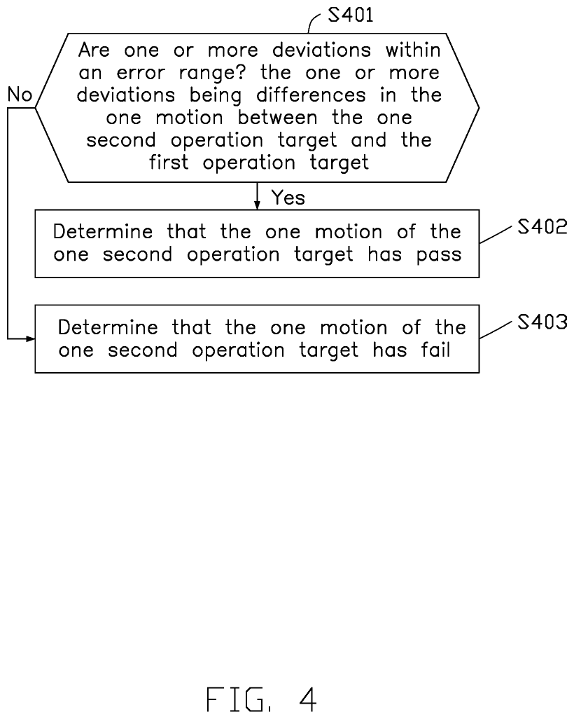

In detail, a process of determining whether the one motion of the one or more second operation target have passed one second operation target of the one or more second operation targets by one second operation target of the one or more second operation targets includes, as shown in FIG. 4:

S401, determining whether one or more deviations are within an error range, the one or more deviations being differences in the one motion between the one second operation target and the first operation target.

In the embodiment, the one or more deviations includes the deviation of the angle of the rotation of the head, and the deviation of the motion track of the body.

The electronic device can determine whether the angle of the rotation of the head is within a first error range according to the motion of the second operation target and the motion of the first operation target. The first error range is an angle range, for example, the first error range is from −5 degrees to 5 degrees.

The electronic device can determine whether the motion track of the body is within a second error range according to the motion of the second operation target and the motion of the first operation target. The second error range is a distance range, for example, the second error range is from −2 centimeters to 2 centimeters.

It can be understood that, the first error range and the second error range can be set according to the need.

If the one or more deviations are within an error range, the procedure goes to S402. If the one or more deviations are out of the error range, the procedure goes to S403.

It can be understood that, the method can determine the deviations one or one, or simultaneously, the disclosure is not limited herein.

S402, determining that the one motion of the one second operation target has pass.

S403, determining that the one motion of the one second operation target has fail.

For example, a motion of the first operation target is: the yaw angle of the rotation of the head toward an up direction is 20 degrees, the moving of the left upper arm and the moving of the left lower arm each toward the right direction is 10 centimeters, the moving of the left upper arm and the moving of the left lower arm each toward the up direction is 5 centimeters, and the moving of the right upper arm and the moving of the right lower arm each toward the down direction is 20 centimeters. A corresponding motion of a second operation target is: the yaw angle of the rotation of the head toward an up direction is 16 degrees, the moving of the left upper arm and the moving of the left lower arm each toward the right direction is 8 centimeters, the moving of the left upper arm and the moving of the left lower arm each toward the up direction is 7 centimeters, and the moving of the right upper arm and the moving of the right lower arm each toward the down direction is 18 centimeters. If the first error range is from −3 degrees to 3 degrees, and the second error range is from −1 centimeters to 1 centimeters, the electronic device can determine that the one motion of the one second operation target is failed.

S303, counting the first number, the first number being a number of the motions of each of the one or more second operation targets having pass.

S304, counting a third number, the third number being a number of the motions of each of the one or more second operation targets having fail.

S305, determining a pass rate of the motion of the second operation target according to a rate of the pass motion.

In the embodiment, the rate of the pass motion is a rate of the first number to the second number.

In some embodiments, the electronic device counts the total number of the motions of each second operation target to pass to be the second number, and counts the number of the motions of each of the one or more second operation targets having pass to be the first number, determines the rate of the first number to the second number, to determine the pass rate of the motions of the second operation target. The second number is the number of the motions that each of the one or more second operation targets acts following as the guiding information.

It can be understood that, S304 can be omitted, and the disclosure is not limited herein.

In some embodiments, if the pass rate of the motions of the second operation target is less than a first threshold value, the electronic device generates an alarm. The alarm is configured to prompt that the motions of the second operation target are abnormal, for example have failed.

It can be understood that, the first threshold value can be set according to the need, for example, the first threshold value is 0.6.

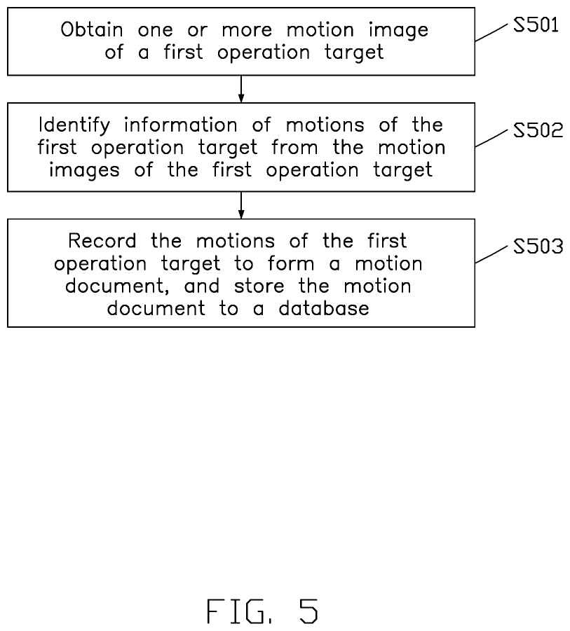

In some embodiments, before obtaining the motion document of the first operation target, the method further includes, as shown in FIG. 5:

S501, obtaining one or more motion image of the first operation target.

S502, identifying information of the motions of the first operation target from the motion images of the first operation target.

It can be understood that, a process of S501 is similar to a process of S203, and a process of S502 is similar to a process of S204, the disclosure is not limited herein.

S503, recording the motions of the first operation target to form the motion document, and storing the motion document to a database.

In some embodiments, the electronic device can store the motion document to different databases according to different formats of the motion document. Different database store different formats of the motion document, thus it is convenient for quickly searching the motion document.

In some embodiments, the electronic device records the motion of the first operation target with the nature language format to form the motion document with the nature language format, and stores the motion document to the first database. Where, the first database is configured to store the data with the nature language format. It can be understood that, the first database can store one or more motion documents of the first operation target with the nature language format, the disclosure is not limited herein.

In some embodiments, the electronic device records the motion of the first operation target with the machine language format to form the motion document with the machine language format, and stores the motion document to the second database. Where, the second database is configured to store the data with the machine language format. It can be understood that, the second database can store one or more motion documents of the first operation target with the machine language format, the disclosure is not limited herein.

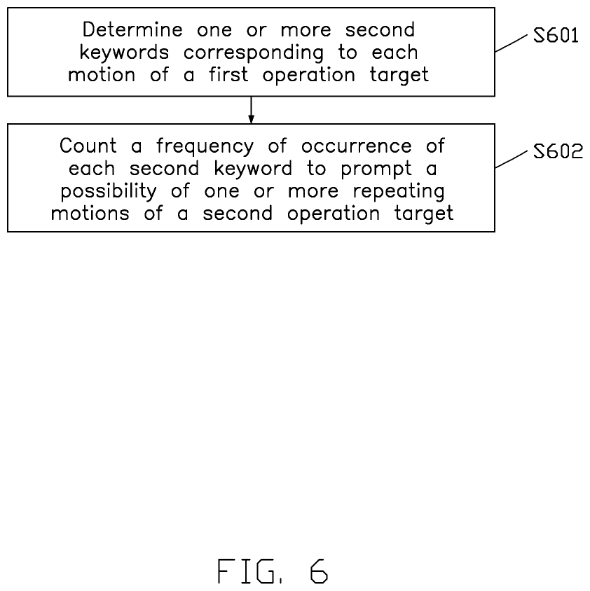

In some embodiments, before the recording the motions of the first operation target to form the first motion document, the method further includes, as shown in FIG. 6:

S601, determining one or more second keywords corresponding to each motion of the first operation target.

S602, counting a frequency of occurrence of each second keyword to prompt a possibility of one or more repeating motions of the second operation target.

For example, the electronic device identifies that the information of the motions of the first operation target from the motion images of the first operation target is: no rotating of the head, the moving of the left hand toward the left direction being about 20 centimeters, and the moving of the right hand toward the right direction being about 10 centimeters. The electronic device can perform a text segmentation or a semantic segmentation on the information of the motions to extract second keywords, such as the second keywords: head, no, rotating, left hand, toward, left, moving, about, 20, centimeters, right hand, toward, left, moving, about, 10, centimeters. The electronic device further counts the frequency of occurrence of each second keyword, as shown in a table 1. The electronic device can display the frequency of occurrence of each second keyword via the display panel, to prompt a user to pay attention to one or more second keywords whose frequencies are highest and to prompt the user to determine whether one or more repeating motions are existed. If one or more repeating motions are existed, the electronic device can receive a deleting operation from the user, and delete the one or more repeating motions according to the deleting operation, to optimize the motions of the first operation target.

TABLE 1
Frequency of occurrence of each second keyword

| Second keyword | Frequency of occurrence |
|---|---|
| Head | 1 |
| No | 1 |
| Rotating | 1 |
| Left hand | 1 |
| Toward | 2 |
| Left | 2 |
| Moving | 2 |
| About | 2 |
| 20 | 1 |
| Centimeters | 2 |
| Right hand | 1 |
| 10 | 1 |

In some embodiments, the electronic device can establish an index value according to each second keyword, as shown in a table 2.

TABLE 2
Index value of each second keyword

| Index value | Second keyword | Frequency of occurrence |
|---|---|---|
| 1 | Head | 1 |
| 2 | No | 1 |
| 3 | Rotating | 1 |
| 4 | Left hand | 1 |
| 5 | Toward | 2 |
| 6 | Left | 2 |
| 7 | Moving | 2 |
| 8 | About | 2 |
| 9 | 20 | 1 |
| 10 | Centimeters | 2 |
| 11 | Right hand | 1 |
| 12 | 10 | 1 |

The electronic device can reversely arrange the index value according to the frequency of occurrence of each second keyword, as shown in a table 3. Where the one or more second keywords whose frequencies of occurrence are highest are arranged at front positions, thus it is convenient for the user to view the one or more second keywords whose frequencies of occurrence are highest.

TABLE 3
Reversible arrangement of the index value

| Index value | Second keyword | Frequency of occurrence |
|---|---|---|
| 5 | Toward | 2 |
| 6 | Left | 2 |
| 7 | Moving | 2 |
| 8 | About | 2 |
| 10 | Centimeters | 2 |
| 1 | Head | 1 |
| 2 | No | 1 |
| 3 | Rotating | 1 |
| 4 | Left hand | 1 |
| 9 | 20 | 1 |
| 11 | Right hand | 1 |
| 12 | 10 | 1 |

In the disclosure, the electronic device generates the guiding information to guide the one or more motions of the second operation target according to the first motion document which records the one or more motions of the first operation target. The electronic device then identifies the one or more motions of the second operation target from the one or more motion images of the second operation target, and determines the pass rate of the motions of the second operation target according to the information of the motions of the first operation target and the information of the motions of the second operation target. Thus, the disclosure can quantitatively evaluate the motions of the second operation target by taking the motions of the first operation target as a reference, and a result of the standardized work can be efficiently evaluated accordingly. Thereof, an efficient reference basis can be provided for optimizing a manner for managing the standardized work.

It can be understood that, each second operation target can perform the motions after listening or viewing the guiding information, or can perform the motions when the guiding information is broadcasted or displayed, the disclosure is not limited herein.

The disclosure further provides a storage medium configured to store one or more programs. The processor can execute the one or more programs to accomplish the steps of the exemplary method.

The storage medium includes a volatile or nonvolatile, removable or non-removable medium implemented by any method or technology for storage of information (such as computer readable instructions, data structures, program modules or other data), as is well known to one of ordinary skill in the art. The storage medium includes, but is not limited to, Random Access Memory (RAM), Read-Only Memory (ROM), Electrically Erasable Programmable Read-Only Memory (EEPROM), flash memory or other memory technology, Compact Disc Read-Only Memory (CD-ROM), digital versatile disk (DVD) or other optical disk storage, magnetic cassette, magnetic tape, magnetic disk storage or other magnetic storage device, or any other medium which can be used for storing the desired information and which can be accessed by a computer.

It should be emphasized that the above-described embodiments of the present disclosure, including any particular embodiments, are merely possible examples of implementations, set forth for a clear understanding of the principles of the disclosure. Many variations and modifications can be made to the above-described embodiment(s) of the disclosure without departing substantially from the spirit and principles of the disclosure. All such modifications and variations are intended to be included herein within the scope of this disclosure and protected by the following claims.

What is claimed is:

1. A method for managing motion information comprising:
obtaining a motion document of a first operation target, the motion document of the first operation target recording information of one or more motions of the first operation target;
generating guiding information according to the motion document of the first operation target, the guiding information being configured to guide one or more motions of one or more second operation targets;
obtaining one or more motion images of each of the one or more second operation targets;
identifying information of one or more motions of each of the one or more second operation targets from the one or more motion images of each of the one or more second operation targets; and
determining a pass rate of the one or more motions of each of the one or more second operation targets according to the information of the one or more motions of the first operation target and the information of the one or more motions of each of the one or more second operation targets.

2. The method according to claim 1, wherein the determining the pass rate further comprises:
comparing the information of the one or more motions of each of the one or more second operation targets with the information of the one or more motions of the first operation target one motion of the one or more motions by one motion of the one or more motions;
determining whether the one motion of the one or more second operation targets have passed one second operation target of the one or more second operation targets by one second operation target of the one or more second operation targets;
determining the pass rate of the one or more motions of each of the one or more second operation targets according to a first number and a second number, wherein the first number is a number of the motions of each of the one or more second operation targets having pass, and the second number is a total number of the motions of each of the one or more second operation targets to pass.

3. The method according to claim 2, wherein the determining whether the one motion of the one or more second operation targets have passed one second operation target of the one or more second operation targets by one second operation target of the one or more second operation targets comprises:
determining whether one or more deviations are within an error range, the one or more deviations being differences in the one motion between the one second operation target and the first operation target;
determining that the one motion of the one second operation target has pass if the one or more deviations are within the error range.

4. The method according to claim 3, wherein the determining whether one or more deviations are within the error range comprises:
determining whether an angle of a rotation of a head is within a first error range according to one or more positions of a reference point of the head in corresponding motion images of the second operation target; and
determining whether a motion track of a body is within a second error range according to one or more positions of one or more reference points of the body in corresponding motion images of the second operation target.

5. The method according to claim 1, wherein each of the one or more motions of the first operation target comprising one or more actions, the obtaining the motion document of the first operation target comprises:
searching the motion document of the first operation target in a first database according to a name or one or more first keywords of the motion document of the first operation target, the first database being configured to store one or more motion documents of the first operation target with a nature language format; and/or
searching the motion document of the first operation target in a second database according to a motion track of one or more reference points corresponding to at least one action of the one or more actions in the one or more motions, the second database being configured to store one or more motion documents of the first operation target with a machine language format.

6. The method according to claim 1, wherein the method further comprises:
obtaining one or more motion images of the first operation target;
identifying information of the one or more motions of the first operation target from the one or more motion images of the first operation target;
recording the information of the one or more motions of the first operation target to form the motion document of the first operation target; and
storing the motion document of the first operation target to a database.

7. The method according to claim 6, wherein before the recording the information of the one or more motions of the first operation target to form the motion document of the first operation target, the method further comprises:
determining one or more second keywords corresponding to each of the one or more motions of the first operation target;
counting a frequency of occurrence of each of the one or more second keywords to prompt a possibility of one or more repeating motions of the second operation target.

8. The method according to claim 1, wherein the method further comprises:
generating an alarm if the pass rate of the one or more motions of a second operation target of the one or more second operation targets is less than a first threshold value, the alarm being configured to prompt that the one or more motions of the second operation target have failed.

9. An electronic device comprising:
a storage unit;
at least one processor; and
the storage unit storing one or more programs, which when executed by the at least one processor, cause the at least one processor to:
obtain a motion document of a first operation target, the motion document of the first operation target recording information of one or more motions of the first operation target;
generate guiding information according to the motion document of the first operation target, the guiding information being configured to guide one or more motions of one or more second operation targets;
obtain one or more motion images of each of the one or more second operation targets;
identify information of one or more motions of each of the one or more second operation targets from the one or more motion images of each of the one or more second operation targets; and
determine a pass rate of the one or more motions of each of the one or more second operation targets according to the information of the one or more motions of the first operation target and the information of the one or more motions of each of the one or more second operation targets.

10. The electronic device according to claim 9, further causing the at least one processor to:
compare the information of the one or more motions of each of the one or more second operation targets with the information of the one or more motions of the first operation target one motion of the one or more motions by one motion of the one or more motions;
determine whether the one motion of the one or more second operation targets have passed one second operation target of the one or more second operation targets by one second operation target of the one or more second operation targets;
determine the pass rate of the one or more motions of each of the one or more second operation targets according to a first number and a second number, wherein the first number is a number of the motions of each of the one or more second operation targets having pass, and the second number is a total number of the motions of each of the one or more second operation targets to pass.

11. The electronic device according to claim 10, further causing the at least one processor to:
determine whether one or more deviations are within an error range, the one or more deviations being differences in the one motion between the one second operation target and the first operation target;
determine that the one motion of the one second operation target has passed if the one or more deviations are within the error range.

12. The electronic device according to claim 11, further causing the at least one processor to:
determine whether an angle of a rotation of a head is within a first error range according to one or more positions of a reference point of the head in corresponding motion images of the second operation target; and
determine whether a motion track of a body is within a second error range according to one or more positions of one or more reference points of the body in corresponding motion images of the second operation target.

13. The electronic device according to claim 9, further causing the at least one processor to:
search the motion document of the first operation target in a first database according to a name or one or more first keywords of the motion document of the first operation target, the first database being configured to store one or more motion documents of the first operation target with a nature language format; and/or
search the motion document of the first operation target in a second database according to a motion track of one or more reference points corresponding to at least one action of the one or more actions in the one or more motion, the second database being configured to store one or more motion documents of the first operation target with a machine language format.

14. The electronic device according to claim 9, further causing the at least one processor to:
determine one or more second keywords corresponding to each of the one or more motions of the first operation target before recording the information of the one or more motions of the first operation target to form the motion document of the first operation target;
count a frequency of occurrence of each of the one or more second keywords to prompt a possibility of one or more repeating motions of the second operation target.

15. A non-transitory storage medium storing a set of commands, when the commands being executed by at least one processor of a vehicle, causing the at least one processor to:
obtain a motion document of a first operation target, the motion document of the first operation target recording information of one or more motions of the first operation target;
generate guiding information according to the motion document of the first operation target, the guiding information being configured to guide one or more motions of one or more second operation targets;
obtain one or more motion images of each of the one or more second operation targets;
identify information of one or more motions of each of the one or more second operation targets from the one or more motion images of each of the one or more second operation targets; and
determine a pass rate of the one or more motions of each of the one or more second operation targets according to the information of the one or more motions of the first operation target and the information of the one or more motions of each of the one or more second operation targets.

16. The non-transitory storage medium according to claim 15, further causing the at least one processor to:
compare the information of the one or more motions of each of the one or more second operation targets with the information of the one or more motions of the first operation target one motion of the one or more motions by one motion of the one or more motions;
determine whether the one motion of the one or more second operation targets have passed one second operation target of the one or more second operation targets by one second operation target of the one or more second operation targets;
determine the pass rate of the one or more motions of each of the one or more second operation targets according to a first number and a second number, wherein the first number is a number of the motions of each of the one or more second operation targets having passed, and the second number is a total number of the motions of each of the one or more second operation targets to pass.

17. The non-transitory storage medium according to claim 16, further causing the at least one processor to:
determine whether one or more deviations are within an error range, the one or more deviations being differences in the one motion between the one second operation target and the first operation target;
determine that the one motion of the one second operation target has passed if the one or more deviations are within the error range.

18. The non-transitory storage medium according to claim 17, further causing the at least one processor to:
determine whether an angle of a rotation of a head is within a first error range according to one or more positions of a reference point of the head in corresponding motion images of the second operation target; and
determine whether a motion track of a body is within a second error range according to one or more positions of one or more reference points of the body in corresponding motion images of the second operation target.

19. The non-transitory storage medium according to claim 15, further causing the at least one processor to:
search the motion document of the first operation target in a first database according to a name or one or more first keywords of the motion document of the first operation target, the first database being configured to store one or more motion documents of the first operation target with a nature language format; and/or
search the motion document of the first operation target in a second database according to a motion track of one or more reference points corresponding to at least one action of the one or more actions in the one or more motion, the second database being configured to store one or more motion documents of the first operation target with a machine language format.

20. The non-transitory storage medium according to claim 15, further causing the at least one processor to:
determine one or more second keywords corresponding to each of the one or more motions of the first operation target before recording the information of the one or more motions of the first operation target to form the motion document of the first operation target;
count a frequency of occurrence of each of the one or more second keywords to prompt a possibility of one or more repeating motions of the second operation target.
